(19) United States
(12) Patent Application Publication
(10) Pub. No.: US 2019/0355946 A1
(43) Pub. Date: Nov. 21, 2019

(54) POWER SUPPLY DEVICE AND ELECTRICAL PRODUCT USING SAME

(71) Applicant: Shenzhen Uwell Technology Co., Ltd., Shenzhen (CN)

(72) Inventor: YUCHENG XIAO, Shenzhen (CN)

(21) Appl. No.: 16/034,381

(22) Filed: Jul. 13, 2018

(30) Foreign Application Priority Data
May 15, 2018 (CN) 201820717340.X

(51) Int. Cl. H01M 2/10; H01M 2/26

(52) U.S. Cl. CPC H01M 2/1016; H01M 2/26

(57) ABSTRACT

A power supply device is provided for supplying power for a main body of an electrical product and includes a first battery or a second battery, an upper cover, a housing including a receiving room for receiving the first battery or the second battery therein, a first opening and a second opening respectively connected to the receiving room, a first end including a first mounting portion positioned on a bottom end of the first opening and formed adjacent to the first opening, and a second end including a second mounting portion and a second circular wall connected between the second mounting portion and the second opening and formed adjacent to the second opening. The upper cover is connected to the first mounting portion or the second mounting portion, while the push button is connected to the second mounting portion or the first mounting portion.

### BACKGROUND

### 1. Technical Field

The present disclosure generally relates to electrical products field, and especially relates to an electrical product and a power supply device for supplying for a main body of the electrical product.

### 2. Description of Related Art

A conventional power supply device of an electrical product can only receive a kind of battery therein, some additional accessories should be needed if another kind of battery is needed to replace in the power supply device. In this way, not only the manufacturing cost is increased, but also it is inconvenient to use and carry.

### SUMMARY

The technical problems to be solved: in view of the shortcomings of the related art, the present disclosure relates to a power supply device and an electrical product using same which can receive different kinds of batteries with different power.

The technical solution adopted for solving technical problems of the present disclosure is:

A power supply device is provided for supplying power for a main body of an electrical product and includes a first battery or a second battery, an upper cover, a housing and a push button. The housing includes a receiving room, a first opening, a second opening, a first end and a second end. The first battery or the second battery is received in the receiving room and the receiving room is connected to the first opening and the second opening. The first end includes a first mounting portion positioned on a bottom end of the first opening and adjacent to the first opening, and the second opening includes a second mounting portion and a second circular wall connected between the second mounting portion and the second opening and adjacent to the second opening. The upper cover is connected to the first mounting portion or the second mounting portion, while the push button is connected to the second mounting portion or the first mounting portion.

Wherein a depth of the second circular wall along an axis direction of the housing is same as the length difference of the first battery and the second battery along the axis direction of the housing.

Wherein the upper cover includes a base and a third mounting member, with a diameter of the base greater than that of the third mounting member, the third mounting member includes a third mounting portion formed on the outer periphery thereof and connected to the first mounting portion or the second mounting portion to engage the upper cover with the housing.

Wherein the third mounting member includes a first electrode post formed on an end surface thereof and electrically connected to the first battery or the second battery.

Wherein the upper cover includes an installing hole for receiving the main body of the electrical product therein.

Wherein the push button includes a fourth mounting member and a keying body, with a diameter of the keying body greater than that of the fourth mounting member, the fourth mounting member includes a fourth mounting portion formed on the outer periphery thereof and connected to the first mounting portion or the second mounting portion to engage the push button with the housing.

Wherein the push button further includes an insulating gasket installed on an end surface of the fourth mounting member, the insulating gasket including a plurality of protrusions formed thereon.

Wherein the fourth mounting member includes a second electrode post formed on an end surface thereof and electrically connected to the first battery or the second battery.

Wherein the keying body includes a pressing switch formed on an end surface thereof for switching the electrical product.

Wherein the third mounting portion is a threaded structure and the length along the axis direction of the housing is greater than that of the first mounting member and the second mounting member.

Wherein the keying body further includes a fixing portion formed near an end surface thereof and including a plurality of engraving portions for fixing the push button on the housing.

An electrical product according to an exemplary embodiment of the present disclosure includes a main body and a power supply device mentioned above and engaged with the main body.

The present disclosure provides the advantages as below.

The structure of the present disclosure is provided for receiving different kinds of batteries with different lengths by changing the installation position between the upper cover, the housing and the push button to achieve changing the inner volume of the receiving room.

### BRIEF DESCRIPTION OF THE DRAWINGS

Many aspects of the embodiments can be better understood with reference to the following drawings. The components in the drawings are not necessarily dawns to scale, the emphasis instead being placed upon clearly illustrating the principles of the embodiments. Moreover, in the drawings, like reference numerals designate corresponding parts throughout the several views.

FIG. 1 is an assembly schematic view of a first kind of electrical product in accordance with an exemplary embodiment, shown the first kind of electrical product in a first state.

FIG. 2 is similar to FIG. 1, but shown the first kind of electrical product in a second state.

FIG. 3 is an assembly schematic view of a second kind of electrical product in accordance with an exemplary embodiment, shown the second kind of electrical product in a first state.

FIG. 4 is similar to FIG. 3, but shown the second kind of electrical product in a second state.

FIG. 5 is a partial exploded, schematic view of a power supply device of FIG. 1.

FIG. 6 is an assembly schematic view of the power supply device of FIG. 1, shown the power supply device in a first state.

FIG. 7 is similar to FIG. 6, but shown the power supply device in a second state.

FIG. 8 is a schematic view of a housing of the power supply device of FIG. 5.

FIG. 9 is similar to FIG. 8, but shown the housing from another view.

FIG. 10 is a schematic view of an upper cover of the power supply device of FIG. 5.

FIG. 11 is similar to FIG. 9, but shown the upper cover from another view.

FIG. 12 is a schematic view of a push button of the power supply device of FIG. 5.

FIG. 13 is similar to FIG. 12, but shown the push button from another view.

### DETAILED DESCRIPTION

The disclosure is illustrated by way of example and not by way of limitation in the figures of the accompanying drawings, in which like reference numerals indicate similar elements.

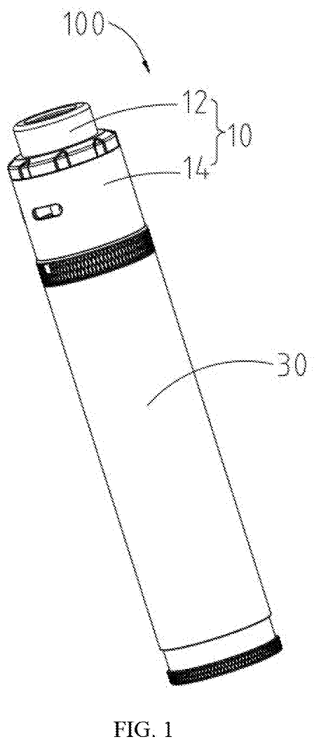

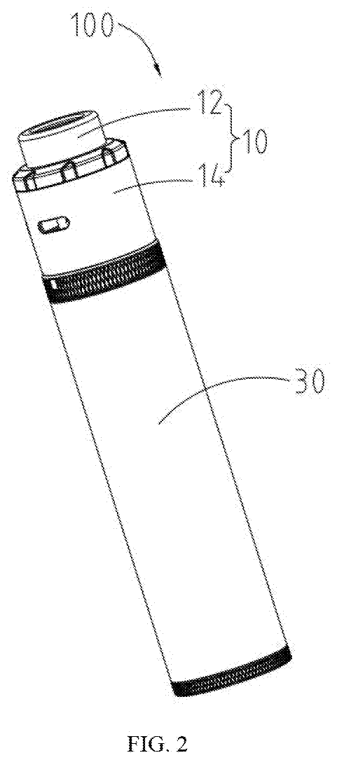

Referring to FIG. 1 and FIG. 2, the electrical product 100 in accordance with an exemplary embodiment of the present disclosure includes a main body 10 and a power supply device 30 engaged with the main body 10 and supplying power for the main body 10.

In an exemplary embodiment of the present disclosure, the electrical product 100 is an electronic cigarette. The main body 10 includes a mouthpiece 12 and an atomizer 14 mounted to the power supply device 30. The mouthpiece 12 is connected to the atomizer 14.

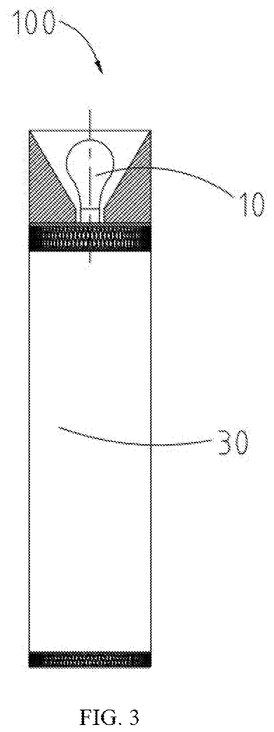

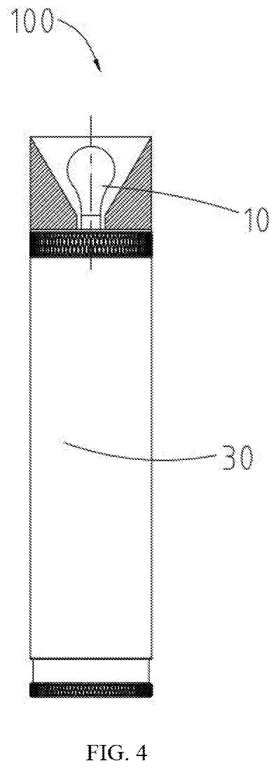

In other exemplary embodiments of the present disclosure, referring to FIG. 3 and FIG. 4, the electrical product 100 is a flashlight and the main body 10 is a bulb mounted to the power supply device 30.

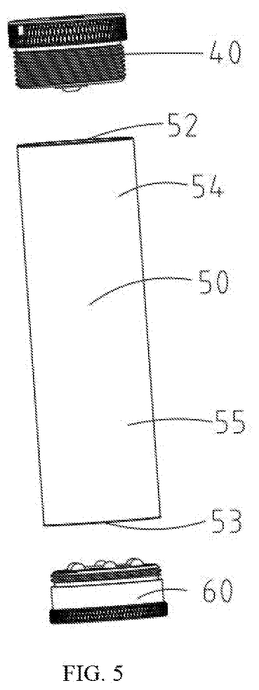

Referring to FIGS. 5-13, the power supply device 30 includes a first battery 70 or a second battery 80, an upper cover 40, a housing 50 and a push button 60. The housing 50 includes a receiving room 51, a first opening 52, a second opening 53, a first end 54 and a second end 55. The first battery 70 or the second battery 80 is received in the receiving room 51 and the receiving room 51 is connected to the first opening 52 and the second opening 53. The first end 54 includes a first mounting portion 542 positioned on a bottom end 520 of the first opening 52 and adjacent to the first opening 52, and the second opening 55 includes a second mounting portion 552 and a second circular wall 554 connected between the second mounting portion 552 and the second opening 53 and adjacent to the second opening 53. The upper cover 40 is connected to the first mounting portion 542 or the second mounting portion 552, while the push button 60 is connected to the second mounting portion 552 or the first mounting portion 542.

In an exemplary embodiment of the present disclosure, the length of the first battery 70 is greater than that of the second battery 80. That is to say, the first battery 70 and the second battery 80 are two different types of batteries.

In an exemplary embodiment of the present disclosure, each of the first mounting portion 542 and the second mounting portion 552 is a threaded structure.

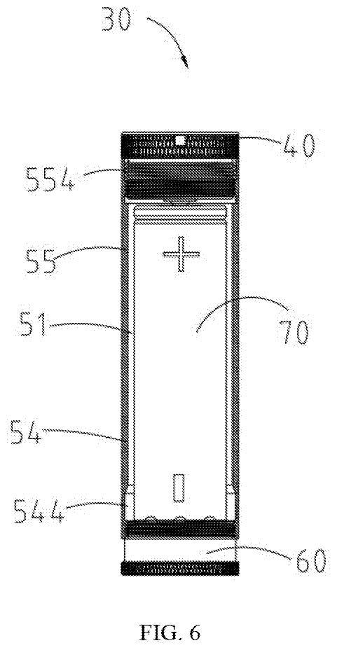

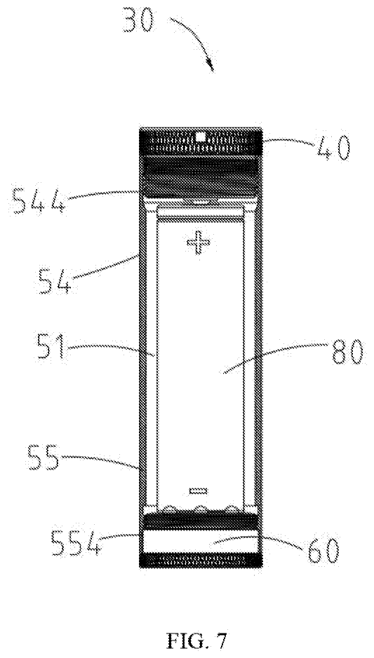

During usage of the power supply device 30, when the first battery 70 is needed to be installed in the receiving room 51 of the housing 50 (seen in FIG. 6), the upper cover 40 is mounted to the second end 55 of the housing 50, and the push button 60 is mounted to the first end 54 of the housing 50. When the second battery 80 is needed to be installed in the receiving room 51 of the housing 50 (seen in FIG. 7), the upper cover 40 is mounted to the first end 54 of the housing 50, and the push button 60 is mounted to the second end 55 of the housing 50. That is to say, the structure of the present disclosure is provided for receiving different kinds of batteries with different lengths by changing the installation position between the upper cover 40, the housing 50 and the push button 60 to achieve changing the inner volume of the receiving room 50. In addition, different types of batteries can be installed in the power supply device 30 or the electrical product 100 without other additional accessories, which not only can reduce the manufacturing cost, but also can improve the convenience of use and carry.

In other exemplary embodiments of the present disclosure, the first end 54 further includes a first circular wall 544 connected between the first mounting portion 542 and the first opening 52 and formed adjacent to the first opening 52.

Referring to FIG. 6 and FIG. 7, a depth of the second circular wall 554 along an axis direction of the housing 50 is same as the length difference of the first battery 70 and the second battery 80 along the axis direction of the housing 50.

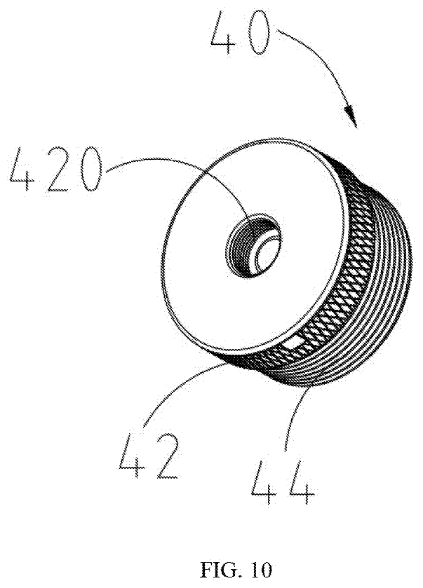

Referring to FIG. 10 and FIG. 11, the upper cover 40 includes a base 42 and a third mounting member 44, with a diameter of the base 42 greater than that of the third mounting member 44. The third mounting member 44 includes a third mounting portion 442 formed on the outer periphery 440 thereof and connected to the first mounting portion 542 or the second mounting portion 552 so that the upper cover 40 can be engaged with the housing 50.

In an exemplary embodiment of the present disclosure, the length of the third mounting portion 442 along the axis direction of the housing 50 is greater than that of the first mounting portion 542 and the second mounting portion 552 along the axis direction of the housing 50.

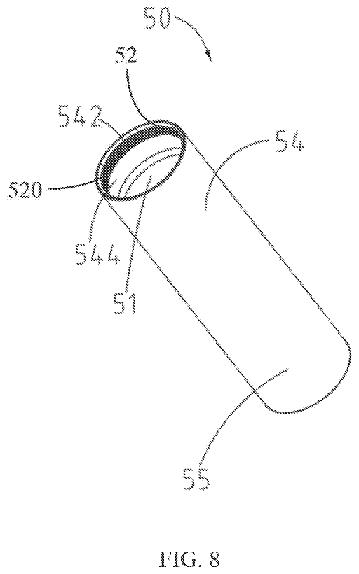

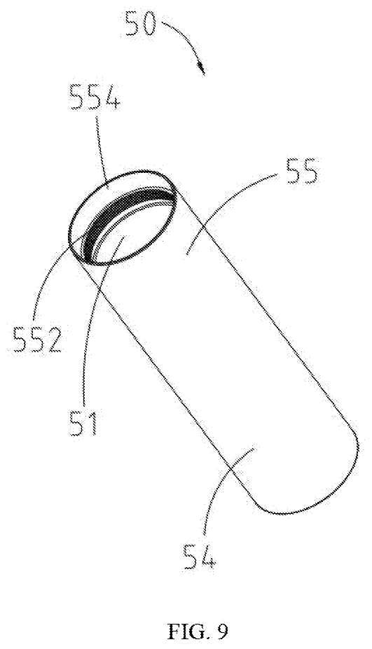

In an exemplary embodiment of the present disclosure, the third mounting portion 442 is a threaded structure and threadedly connected to the first mounting portion 542 and the second mounting portion 552 by screws (seen in FIG. 8 and FIG. 9).

Furthermore, the third mounting member 44 includes a first electrode post 444 formed on an end surface 441 thereof and electrically connected to the first battery 70 or the second battery 80 (seen in FIG. 6 and FIG. 7).

Furthermore, the upper cover 40 includes an installing hole 420 for receiving the main body 10 (seen in FIG. 1) of the electrical product 100 therein.

In an exemplary embodiment of the present disclosure, the atomizer 14 is received in the installing hole 420 by threaded connection.

In other exemplary embodiments of the present disclosure, the bulb is received in the installing hole 420 by threaded connection.

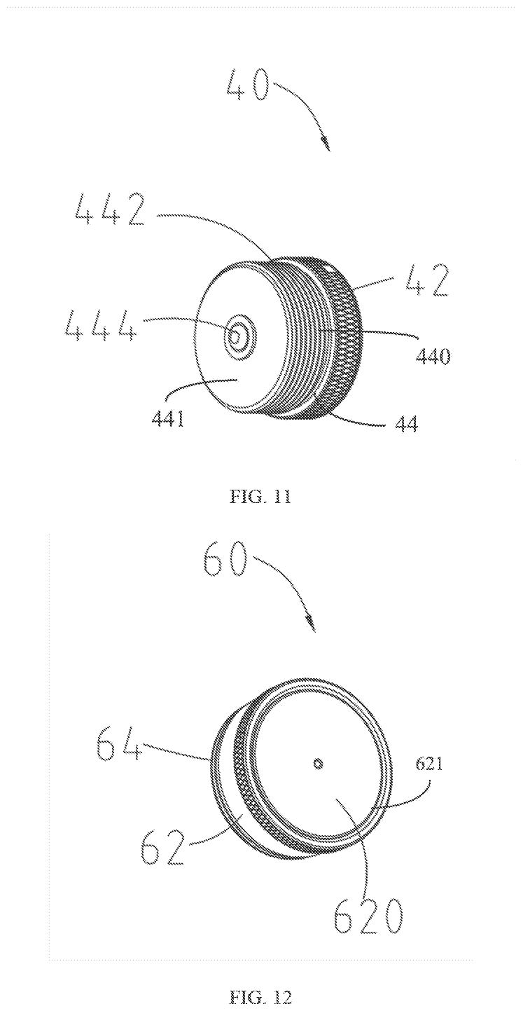

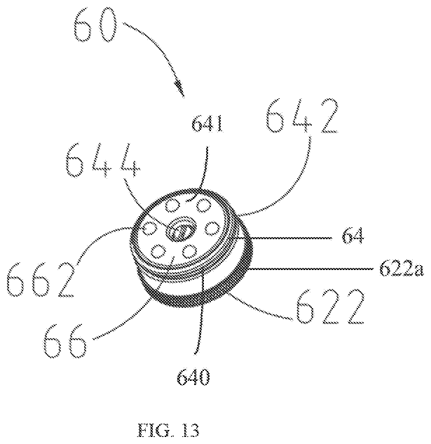

Referring to FIG. 12 and FIG. 13, the push button 60 includes a fourth mounting member 64 and a keying body 62, with a diameter of the keying body 62 greater than that of the fourth mounting member 64. The fourth mounting member 64 includes a fourth mounting portion 642 formed on the outer periphery 640 thereof and connected to the first mounting portion 542 or the second mounting portion 552 so that the push button 60 can be engaged with the housing 50.

In an exemplary embodiment of the present disclosure, the fourth mounting portion 642 is a threaded structure and threadedly connected to the first mounting portion 542 and the second mounting portion 552 by screws (seen in FIG. 8 and FIG. 9).

In an exemplary embodiment of the present disclosure, the structure of the third mounting portion 442 is same as that of the fourth mounting portion 642.

Furthermore, the push button 60 further includes an insulating gasket 66 installed on an end surface 641 of the fourth mounting member 64, and the insulating gasket 66 includes a plurality of protrusions 662 formed thereon.

In an exemplary embodiment of the present disclosure, the insulating gasket 66 is acted as an insulator. At the same time, the plurality of protrusions 662 is acted as a buffer. Furthermore, the protrusion 662 is acted as a similarly elastic configuration so that it can produce a bounce-back effect to make up for the length error of the battery when a force is applied on the protrusion 662.

Furthermore, the fourth mounting member 64 includes a second electrode post 644 formed on the end surface 641 thereof and electrically connected to the first battery 70 or the second battery 80 (seen in FIG. 6 and FIG. 7).

Furthermore, the keying body 62 includes a pressing switch 620 formed on an end surface 621 thereof for switching the electrical product 100. The first battery 70 or the second battery 80 can be electrically connected to the second electrode post 644 via the pressing switch 620 energizing the electrical product 100.

In an exemplary embodiment of the present disclosure, the keying body 62 further includes a fixing portion 622 formed near the end surface 621 thereof. The fixing portion 622 includes a plurality of engraving portions 622a for fixing the push button 62 on the housing 50.

Referring to FIGS. 1-13, when assembling the power supply device 30, the first battery 70 or the second battery 80 is first received in the receiving room 51 of the housing 50, the third mounting portion 442 of the upper cover 40 is connected to the second mounting portion 552 or the first mounting portion 542, and then the main body 10 is installed in the installing hole 420 of the upper cover 40. Specifically, when the first battery 70 is received in the receiving room 51 (seen in FIG. 6), a front end of the third mounting portion 442 is threadedly connected to the second mounting portion 552, the fourth mounting portion 642 of the push button 60 is threadedly engaged with the first mounting portion 542. When the second battery 80 is received in the receiving room 51 (seen in FIG. 7), a back end of the third mounting portion 442 is threadedly connected to the first mounting portion 542 of the housing 50, and the fourth mounting portion 642 of the push button 60 is threadedly engaged with the second mounting portion 552.

During usage of the power supply device 30, if the battery needs to be replaced, the upper cover 40 is installed on the second end 55 or the first end 54 according to the length of the battery, and the push button 60 is accordingly installed on the first end 54 or the second end 55. In this way, it is no need to add additional auxiliary components to replace the battery, which can greatly improve the convenience of use and reduce the manufacturing cost.

Furthermore, power varies according to the type of battery. That is to say, the power supply device 30 of the present disclosure can provide various kinds of batteries with different power.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. A power supply device provided for supplying power for a main body of an electrical product and comprising a first battery or a second battery, an upper cover, a housing and a push button; the housing comprising a receiving room for receiving the first battery or the second battery therein, a first opening and a second opening respectively connected to the receiving room, a first end comprising a first mounting portion positioned on a bottom end of the first opening and formed adjacent to the first opening, and a second end comprising a second mounting portion and a second circular wall connected between the second mounting portion and the second opening and formed adjacent to the second opening; and wherein the upper cover is connected to the first mounting portion or the second mounting portion, while the push button is connected to the second mounting portion or the first mounting portion.

2. The power supply device as claimed in claim 1, wherein a depth of the second circular wall along an axis direction of the housing is same as the length difference of the first battery and the second battery along the axis direction of the housing.

3. The power supply device as claimed in claim 1, wherein the upper cover comprises a base and a third mounting member, with a diameter of the base greater than that of the third mounting member, the third mounting member comprises a third mounting portion formed on the outer periphery thereof and connected to the first mounting portion or the second mounting portion to engage the upper cover with the housing.

4. The power supply device as claimed in claim 3, wherein the third mounting member comprises a first electrode post formed on an end surface thereof and electrically connected to the first battery or the second battery.

5. The power supply device as claimed in claim 3, wherein the upper cover comprises an installing hole for receiving the main body of the electrical product therein.

6. The power supply device as claimed in claim 1, wherein the push button comprises a fourth mounting member and a keying body, with a diameter of the keying body greater than that of the fourth mounting member, the fourth mounting member comprises a fourth mounting portion formed on the outer periphery thereof and connected to the first mounting portion or the second mounting portion to engage the push button with the housing.

7. The power supply device as claimed in claim 6, wherein the push button further comprises an insulating gasket installed on an end surface of the fourth mounting member, the insulating gasket comprising a plurality of protrusions formed thereon.

8. The power supply device as claimed in claim 7, wherein the fourth mounting member comprises a second electrode post formed on an end surface thereof and electrically connected to the first battery or the second battery.

9. The power supply device as claimed in claim 6, wherein the keying body comprises a pressing switch formed on an end surface thereof for switching the electrical product.

10. The power supply device as claimed in claim 3, wherein the third mounting portion is a threaded structure and its length along the axis direction of the housing is greater than that of the first mounting member and the second mounting member.

11. The power supply device as claimed in claim 9, wherein the keying body further comprises a fixing portion formed near an end surface thereof and comprising a plurality of engraving portions for fixing the push button on the housing.

12. An electrical product comprising a main body and a power supply device engaged with the main body, the power supply device comprising a first battery or a second battery, an upper cover, a housing and a push button, the housing comprising a receiving room for receiving the first battery or the second battery therein, a first opening and a second opening respectively connected to the receiving room, a first end comprising a first mounting portion positioned on a bottom end of the first opening and formed adjacent to the first opening, and a second end comprising a second mounting portion and a second circular wall connected between the second mounting portion and the second opening and formed adjacent to the second opening; and wherein the upper cover is connected to the first mounting portion or the second mounting portion, while the push button is connected to the second mounting portion or the first mounting portion.

13. The electrical product as claimed in claim 12, wherein a depth of the second circular wall along an axis direction of the housing is same as the length difference of the first battery and the second battery along the axis direction of the housing.

14. The electrical product as claimed in claim 12, wherein the upper cover comprises a base and a third mounting member, with a diameter of the base greater than that of the third mounting member, the third mounting member comprises a third mounting portion formed on the outer periphery thereof and connected to the first mounting portion or the second mounting portion to engage the upper cover with the housing.

15. The electrical product as claimed in claim 14, wherein the third mounting member comprises a first electrode post formed on an end surface thereof and electrically connected to the first battery or the second battery.

16. The electrical product as claimed in claim 14, wherein the upper cover comprises an installing hole for receiving the main body of the electrical product therein.

17. The electrical product as claimed in claim 12, wherein the push button comprises a fourth mounting member and a keying body, with a diameter of the keying body greater than that of the fourth mounting member, the fourth mounting member comprises a fourth mounting portion formed on the outer periphery thereof and connected to the first mounting portion or the second mounting portion to engage the push button with the housing.

18. The electrical product as claimed in claim 17, wherein the push button further comprises an insulating gasket installed on an end surface of the fourth mounting member, the insulating gasket comprising a plurality of protrusions formed thereon.

19. The electrical product as claimed in claim 17, wherein the keying body comprises a pressing switch formed on an end surface thereof for switching the electrical product, and a fixing portion formed near an end surface thereof and comprising a plurality of engraving portions for fixing the push button on the housing.

20. The electrical product as claimed in claim 18, wherein the fourth mounting member comprises a second electrode post formed on an end surface thereof and electrically connected to the first battery or the second battery.
